(19) United States
(12) Patent Application Publication
(10) Pub. No.: US 2018/0200875 A1
(43) Pub. Date: Jul. 19, 2018

(54) Storage Container

(71) Applicant: TTS Tooltechnic Systems AG & Co. KG, Wendlingen (DE)

(72) Inventors: Lutz Wolle, Burlafingen (DE); Markus Barabeisch, Vohringen (DE)

(21) Appl. No.: 15/743,925

(22) PCT Filed: Jul. 24, 2015
(86) PCT No.: PCT/EP2015/066974

§ 371 Date: Jan. 11, 2018

(51) Int. Cl. B25H 3/02

(52) U.S. Cl. CPC B25H 3/028

(57) ABSTRACT

A storage container provided with a modular container housing, having multiple housing modules arranged above one another in a vertical direction and coupled to one another in pairs. Housing modules that are arranged directly above one another border a respective receiving compartment for a pull-out and push-in drawer element. Each housing module arranged between two receiving compartments is designed as a housing intermediate module, which is provided with a module horizontal wall, from the edge of which an upper module side wall projects upwards and a lower module side wall projects downwards. In this way, each housing intermediate module simultaneously contributes towards forming both a compartment side wall bordering the receiving compartment arranged above the housing intermediate module, and a compartment side wall laterally bordering the receiving compartment arranged under same.

The invention relates to a storage container provided with a modular container housing which has a plurality of housing modules arranged above one another in a height direction and coupled to one another in pairs in a way which prevents their lifting off from one another and which is provided with a plurality of reception compartments, each bounded by two housing modules located directly above one another and open at a front side of the container housing, for pull-out and push-in drawer elements, wherein at least one housing module or each housing module located between two reception compartments is designed as a housing intermediate module which is provided with a module horizontal wall extending at right angles to the height direction between the two reception compartments and a module side wall which is integrated in one piece with the module horizontal wall at the edge of the module horizontal wall and projects upwards.

Such a storage container is known from EP 1 658 160 B1. This known storage container is, for example, composed of three housing modules placed on top of one another in a height direction and latched to one another in pairs. Housing modules which are adjacent to one another in the height direction in each case bound together a reception compartment which is open towards the front of the container housing and in which a drawer element is located in a pull-out and push-in arrangement. Apart from a cover which can be placed on top, the housing modules are uniform in design and have a U-shaped profiling if viewed from the front. Among other features, the housing module located between two reception compartments, which can be described as a housing intermediate module, has a horizontally oriented module horizontal wall with an upper module side wall which exclusively extends upwards and is located on the left-hand and the right-hand side as well as on the rear side. In order to couple the intermediate modules to the housing module placed below, the module horizontal wall has to have a stepped contour in the transitional region to the module side wall, which increases the constructive effort involved and can adversely affect the usable cross-section of the adjacent reception compartments.

From U.S. Pat. No. 5,544,751, too, a storage container is known which comprises several housing modules sitting vertically on top of one another and latched to one another while bounding a reception compartment for drawer elements in pairs. Apart from a case-like upper housing module, all housing modules here have a U-shaped cross-section and a module horizontal wall acting as a base, from which a module side wall exclusively extends upwards.

DE 10 2012 107 955 A1 discloses a container with a base wall, two left-hand and right-hand side walls and a rear wall, the arrangement offering the opportunity to stack several such containers on top of one another and latch them together. Each container can accommodate a pull-out drawer.

From U.S. Pat. No. 5,603,559, a storage container is known in the housing of which several pull-out drawers are arranged. Such a storage container is also disclosed in DE 20 2004 020 112 U1.

DE 20 2009 018 589 U1 discloses a container assembly composed if several stackable containers which can be coupled vertically by means of cabinet locks.

U.S. Pat. No. 3,316,045 and US 2002/0125159 A1 describe storage containers with a one-part carcass in which several drawers are arranged in a pull-out manner and which has an opening on the top side, which can be closed by means of a pivotably mounted cover plate.

The invention is based on the problem of creating a modular storage container which is suitable for accommodating at least two drawer elements and the housing modules of which, while being cost-effective in construction, can easily be coupled to one another.

To solve this problem, it is provided, in combination with the features mentioned above, that at least one housing intermediate module has, in addition to an upper module side wall which projects beyond the module horizontal wall in the upward direction, a lower module side wall which projects beyond the module horizontal wall in the downward direction and therefore contributes to the formation of both a compartment side wall which laterally bounds the reception compartment located above the housing intermediate module and a compartment side wall which laterally bounds the reception compartment located below, wherein the housing intermediate module is coupled at its upper module side wall to a housing module located above and at its lower module side wall to a housing module located below, in each case in a way which prevents lifting-off.

The storage container according to the invention comprises at least one housing intermediate module which is located between two further housing modules in the height direction and coupled both to the housing module located above and to the housing module located below in a way which prevents lifting off one another, forming with each of the two housing modules adjoining it in the height direction a reception compartment for a drawer element. At its lateral edge, the housing intermediate module has a substantially T-shaped profile, with a module side wall projecting both upwards and downwards from the edge of the module horizontal wall, which is oriented transversely to the height direction. The upward-projecting upper module side wall laterally bounds a reception compartment located above the housing intermediate module, while the downward-projecting lower module side wall laterally bounds a reception compartment located below the housing intermediate module. As the housing intermediate module is coupled to the respective adjacent housing module at its upper and lower module side wall, the coupling measures can be implemented independently of the module horizontal wall, which facilitates a simple and cost-effective design of the module horizontal wall and the best possible utilisation of the volume of the associated reception compartment.

Advantageous further developments of the invention emerge from the dependent claims.

If the storage container comprises several housing intermediate modules sitting directly on top of one another, it is advantageous if each of these several housing intermediate modules has an upward-projecting upper module side wall and a downward-projecting lower module side wall. In this case, housing intermediate modules located immediately adjacent to one another in the height direction are coupled to one another in the region of two facing upper and lower module side walls.

If the storage container is provided with several housing intermediate modules, these several housing intermediate modules are preferably designed to be identical.

At the front of the container housing, each reception compartment has a compartment opening for pulling out and pushing in a drawer element. Apart from the compartment opening, each reception compartment is laterally bounded by a compartment side wall which is made up of a module side wall of the housing module immediately adjacent in the height direction and the upper or lower module side wall of the housing intermediate module which is assigned to said adjacent housing module. As a result, the compartment side wall of the reception compartment is formed not only by the associated housing intermediate module, but jointly by this housing intermediate module and the housing module located adjacent thereto in the height direction, wherein the adjacent housing module can be a further housing intermediate module by all means.

Two housing intermediate modules located immediately adjacent to one another in the height direction are preferably coupled by providing a coupling between the upward-projecting upper module side wall of the lower housing intermediate module and the downward-projecting lower module side wall of the housing module placed above. These module side walls are equipped with coupling means to effect the coupling, in particular in the form of latching means.

Among the housing modules of the modular container housing, there are preferably provided, in addition to at least one housing intermediate module, a lower housing end module located at the underside of the container housing and an upper housing end module located at the top side of the container housing. Each of these two housing end modules is coupled to the associated upper or lower module side wall of the housing intermediate module located adjacent in the height direction. A storage container with precisely two reception compartments for a drawer element each comprises a single housing intermediate module located directly between an upper housing end module and a lower housing end module.

The upper housing end module, which completes the storage container at the top, it at its top expediently bounded by a cover wall, on the upward-oriented outside of which a bow-shaped carrying handle is provided, preferably in a pivotable manner The carrying handle can expediently be pivoted between a position of non-use, in which it is pivoted towards the cover wall and in particular recessed into the cover wall, and a position of use, in which it is pivoted into an upright position. With the aid of the carrying handle, the storage container can easily be picked up and transported manually.

The upper cover wall is preferably directly represented by the upper end wall of the upper housing end module. In this case the upper housing end module has a single module horizontal wall which defines both the upper end wall and the cover wall.

In an alternative embodiment, the upper housing end module is designed as a container module which bounds a storage space accessible through an access opening pointing upwards in the height direction, wherein the upper end wall of the upper housing end module forms the base wall of the container module and the cover wall is represented by a cover plate assigned to the access opening and sitting on top of an upper module side wall which projects upwards from the upper end wall of the upper housing end module.

The upper module side wall of the housing intermediate module can have the same wall height in the height direction of the container housing as the lower module side wall projecting downwards from the module horizontal wall in the opposite direction. With regard to the stability of the compartment side wall in particular, however, it has been found to be advantageous if the upper module side wall has in the height direction of the container housing a wall height which is different from the correspondingly measured wall height of the lower module side wall of the same housing intermediate module. An embodiment in which the upward-projecting upper module side wall is higher than the downward-projecting lower module side wall in one and the same housing intermediate module is particularly preferred.

For mutual coupling, the housing modules of the container housing are expediently latched to one another by mutually engaging latching means. They are latched at the module side walls. For reasons of cost, it is advisable to design the cooperating latching means in such a way that the latching connection, once established, cannot be released, giving the container housing the character of a monolithic body in terms of stability irrespective of its modular structure. The coupling measures may, however, be designed to be releasable as well.

For coupling by means of a latching connection, it is expediently provided that each upward-projecting upper module side wall has several first latching means and each downward-projecting lower module side wall has a corresponding number of second latching means which complement the first latching means. Either the first latching means or the second latching means are preferably designed as latching hooks which extend away from the associated module side wall in the height direction and engage a latching edge of the other latching means from behind in the latched state provided for coupling. In the latched state, the mutually assigned upper and lower module side walls of adjacent housing modules are expediently supported on one another by their vertically oriented end faces and are there expediently clamped to one another in the height direction of the container housing by the positively cooperating latching means.

Each latching hook expediently dips into a plug-in receptacle which is formed on the adjacent housing module and open in the height direction on at least one side, and to which the latching edge mentioned above is assigned. The plug-in receptacle is expediently bounded by a lateral boundary wall in which at least one window-type opening is formed, its rim forming the latching edge.

If the container housing has a rectangular outline, which is the preferred shape, each of the upper and lower side walls has two opposite left-hand and right-hand lateral wall sections and a rear wall section bounding the reception compartment at the rear, i.e. opposite the front compartment opening. The latching means are preferably provided exclusively at the lateral wall sections.

The module side walls can be partially broken, in particular for providing a view of the interior of the associated reception compartment. It is, however, deemed to be more advantageous if each compartment side wall, apart from the compartment opening provided at the front, extends as a closed entity around the associated reception compartment.

The storage container expediently comprises a number of drawer elements which at least corresponds to the number of reception compartments. The drawer elements are independently located in their own reception compartments in a pull-out and push-in arrangement. It is expediently possible to pull each drawer element completely out of the associated reception compartment and to remove it from the container housing.

The storage container is preferably designed to be portable. For easy transport, it is expediently provided, as mentioned above, with at least one carrying handle which is preferably located on the top of the container housing. During transport, the drawer elements are expediently pushed fully into the associated reception compartments. Locking means are preferably provided for releasably locking each drawer element to the housing in its fully pushed-in position.

Each drawer element expediently has a base wall and an outer wall which extends around the edge of the base wall and projects upwards. Together with the outer wall, the base wall bounds a drawer interior which can be used for storing any objects, such as tools or ironmongery. The drawer interior can be divided into several interior sections by one or more partitions. For ease of handling when pulling out and pushing in, each drawer element expediently has a handle on the outside—facing away from the drawer interior—of a front outer wall section of the drawer element.

The drawer element is preferably designed without a cover. It is, however, easily possible to provide the drawer element with a removable or pivotable cover for covering the drawer interior at the top. In this case, the drawer element can itself be designed in the manner of a container, for example as a small shell case.

The invention is explained in greater detail below with reference to the accompanying drawing, of which:

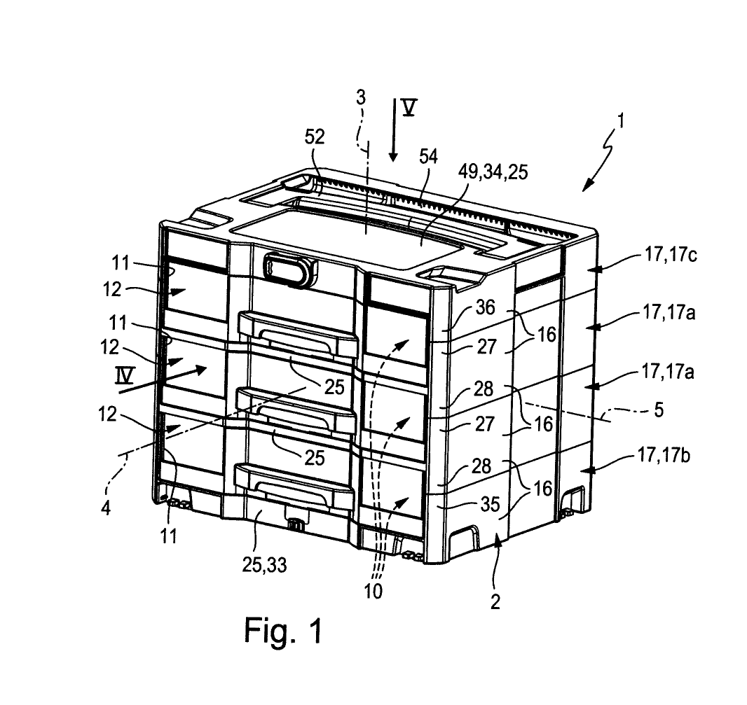

FIG. 1 shows a preferred embodiment of the storage container according to the invention in a variant with two housing intermediate modules, wherein a drawer element is located in each of the three reception compartment defined thereby and wherein all drawer elements are illustrated in the fully pushed-in state,

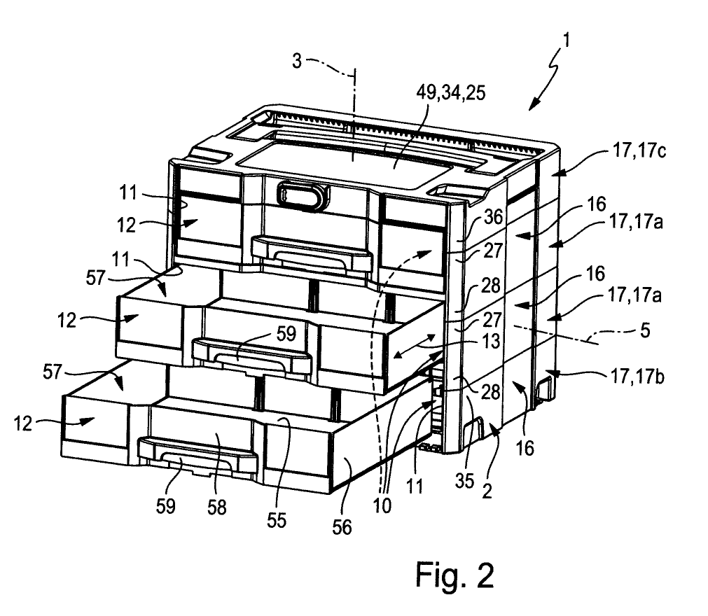

FIG. 2 shows the storage container from FIG. 1 in a state in which drawer elements are pulled out to varying degrees,

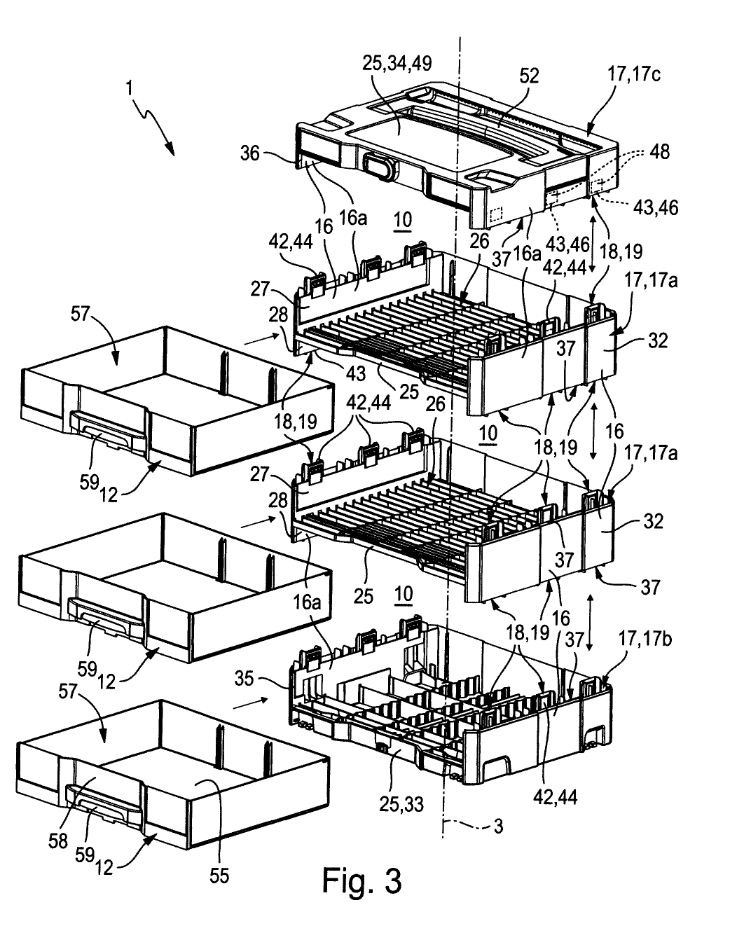

FIG. 3 is an explosive view of the storage container illustrated in FIGS. 1 and 2,

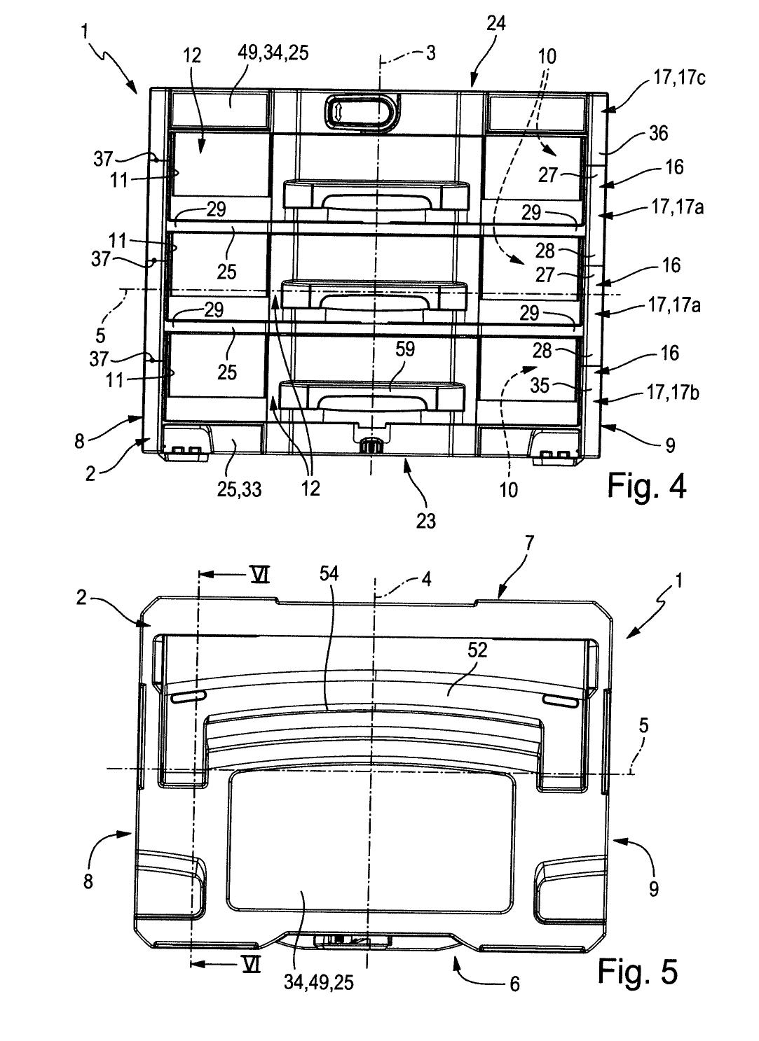

FIG. 4 is a front view of the storage container in a viewing direction according to arrow IV from FIG. 1,

FIG. 5 is a top view of the storage container in a viewing direction according to arrow V from FIG. 1,

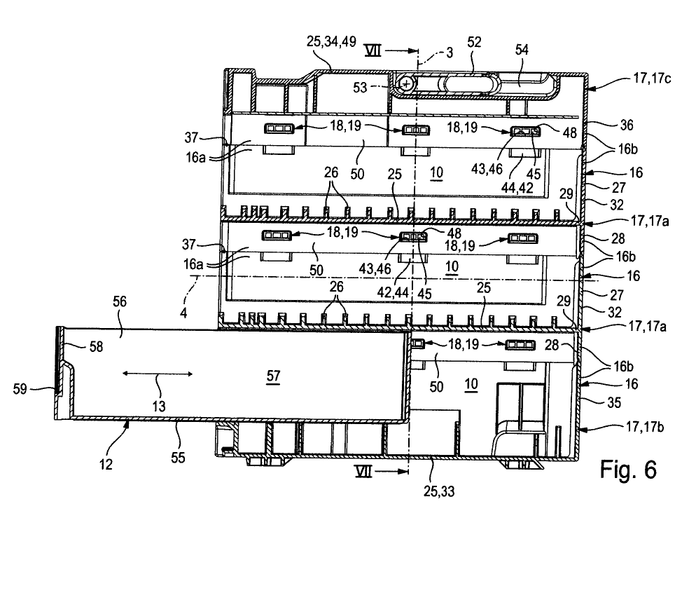

FIG. 6 is a vertical section through the storage container in accordance with sectional plane VI-VI from FIG. 5, illustrating only a drawer element assigned to the lowermost reception compartment—in a partially pulled-out state, and

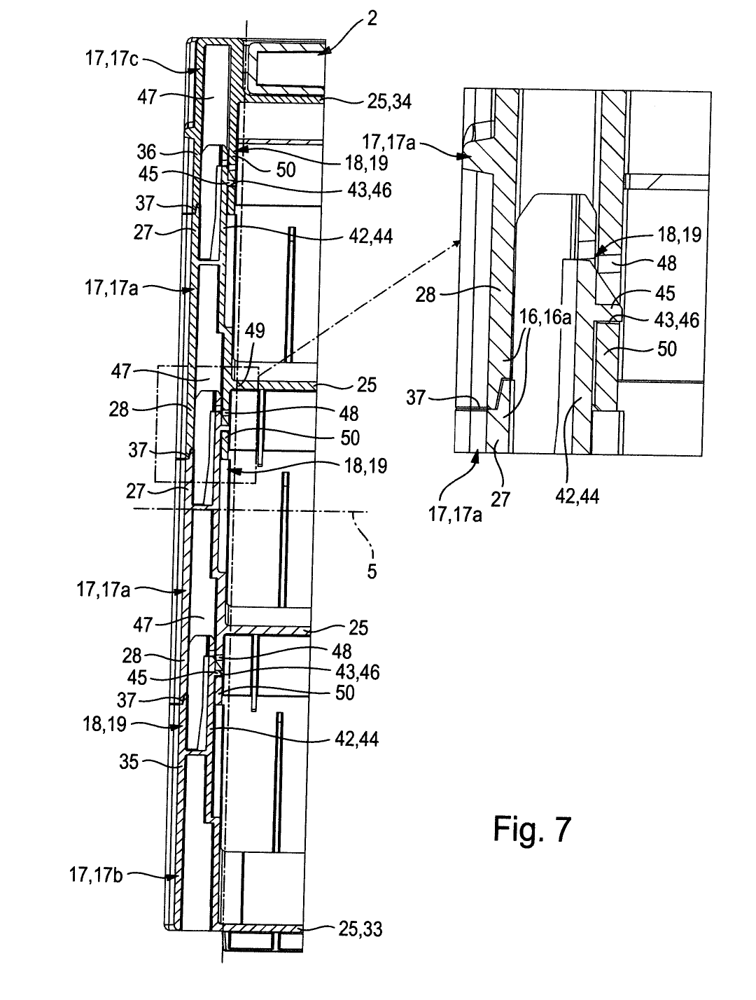

FIG. 7 is a further vertical section through the storage container in accordance with line VII-VII from FIG. 6, limited to the lateral wall region of the container housing for illustrating the latching connections effecting the coupling of the modules, a framed section being shown separately in an enlargement.

The storage container, which is identified by the reference number 1 in its entirety, has a container housing 2 with a vertical axis 3, the axial direction of the vertical axis 3 being hereinafter also referred to as the height direction 3.

The container housing 2 further has a longitudinal axis 4 perpendicular to the vertical axis 3 and a transverse axis 5 perpendicular to the longitudinal axis 4. The axial direction of the longitudinal axis 4 defines a depth direction, and the axial direction of the transverse axis 5 defines a width direction of the container housing 2. In the usual position of use of the storage container, the vertical axis is oriented vertically.

In a plane perpendicular to the vertical axis 3 the container housing 2 preferably has an at least substantially rectangular outline, which can be seen particularly clearly in FIG. 5. As a whole, the container housing 2 preferably has a cuboid basic structure.

The container housing 2 has a front side 6 oriented in the axial direction of the longitudinal axis 4 and a rear side 7 opposite the former. The container housing 2 further has two lateral outsides 8, 9 arranged opposite each other and oriented in the axial direction of the transverse axis 5.

The container housing 2 bounds a plurality of reception compartments 10 arranged on top of one another in the vertical direction 3. At least two reception compartments 10 are provided, the number of compartments being arbitrary in principle. The storage container 1 of the illustrated embodiment is provided with three reception compartments 10.

Each reception compartment 10 is accessible from the outside through its own compartment opening 11 located on the front side 6 and cut out of the container housing 2. In each reception compartment 10, a drawer element 12 is located; within an operating movement 13 indicated by a double-headed arrow and oriented in the axial direction of the longitudinal axis 4, this can optionally be pulled out of the associated reception compartment 10 or pushed into the respective reception compartment 10.

In FIG. 2, the topmost of three drawer elements 12 is shown in the pushed-in home position. The middle drawer element 12 placed below has been partially pulled out of the associated reception compartment 10, and the lowermost drawer element 12 is shown in a position in which it has been completely removed from the associated reception compartment 10.

For each reception compartment 10, the container housing 2 forms a compartment side wall 16, which bounds the associated reception compartment 10 at the sides oriented at right angles to the vertical axis 3—with the exception of the region of the compartment opening 11. Apart from the compartment opening 11 facilitating access to the drawer element 12, each compartment side wall 16 preferably extends as a closed wall around the associated reception compartment 10.

Accordingly, each compartment side wall 16 has two lateral compartment side wall sections 16a assigned to the lateral outsides 8, 9 and a rear compartment side wall section 16b located on the rear opposite the compartment opening 11. The rear compartment side wall section 16b can be dispensed with at least partially, so that the drawer element 12 remains visible from the rear side 7 in the associated reception compartment 10.

The container housing 2 is constructed in a modular manner and composed of a plurality of housing modules 17, which are arranged on top of one another in the axial direction of the vertical axis 3 and sit on top of one another. Housing modules 17 which are immediately adjacent to one another in the height direction 3 are coupled to one another in such a way that relative movement is impossible in any spatial direction. This being so, the coupled housing modules 17 can neither be displaced relative to one another in a horizontal plane extending at right angles to the vertical axis 3 nor lifted off one another in the height direction 3.

The responsibility for the cohesion of the module assembly lies with coupling devices 18 provided between housing modules 17 which are adjacent to one another in the height direction 3. As in the illustrated embodiment, these are preferably designed as latching connection devices 19. During the assembly of the container housing 2, the housing modules 17 can be placed on top of one another in the height direction 3 and partially plugged into one another by applying a defined actuating force, thereby being latched to one another. The latching connection devices 19 are preferably non-releasable, so that an unintentional breaking up of the module assembly can be reliably excluded. In principle, however, it would be possible to design the coupling devices 18 in a manner which allows their decoupling.

Housing modules 17 which are arranged directly on top of one another in the height direction 3 of the container housing 2 together bound one of the reception compartments 10 each. Such housing modules 17 which bound both a reception compartment 10 placed above and a reception compartment 10 placed below shall be described as housing intermediate modules 17a.

The storage container 1 contains at least one such housing intermediate module 17a. To obtain a larger number of reception compartments 10, the storage container 1 can, however, alternatively comprise several housing intermediate modules 17a arranged directly on top of one another and coupled to one another. The storage container 1 of the illustrated embodiment contains two housing intermediate modules 17a.

In the region of its underside 23 pointing downwards relative to the axial direction of the vertical axis 3, the container housing 2 has a housing module 17 described as lower housing end module 17b. In the region of the opposite top side 24, the container housing 2 has a housing module 17 described as upper housing end module 17c. Together with the lower housing end module 17b, the lowermost housing intermediate modules 17a bounds a lowermost reception compartment 10, while the topmost housing intermediate modules 17a bounds a topmost reception compartment 10 with the upper housing end module 17c.

If the storage container 1 has only one housing intermediate module 17a, this, together with the lower housing end module 17b, bounds the lower of two reception compartments 10 and, together with the upper housing end module 17c, the upper of the two reception compartments 10.

Each housing intermediate module 17a has a module horizontal wall 25, which extends transversely and in particular at right angles to the vertical axis 3. Each of these module horizontal walls 25 forms the base of the reception compartment 10 placed above and at the same time the ceiling of the reception compartment 10 placed below. The module horizontal wall 25 is preferably designed to be plate-shaped, being expediently continuous. For stiffening, in particular, it can however be provided with integral ribbing 26 at the top side and/or the underside.

The module horizontal wall 25 expediently has an at least substantially rectangular outline, approximately in accordance with the outline of the container housing 2.

At the edges, two module side walls designated hereinafter as upper module side wall 27 and as lower module side wall 28 for easier differentiation are integrally formed on the module horizontal wall 25 of at least one housing intermediate module 17a and preferably of each housing intermediate module 17a. The upper module side wall 27 projects upwards in the height direction 3 from the outer edge 29 of the module horizontal wall 25, while the lower module side wall 28 projects downwards in the height direction 3 from this outer edge 29.

The upper module side wall 27 preferably merges directly and integrally into the lower module side wall 28 of the same housing intermediate module 17a. The transition is gapless and without a break, in particular at the outer surface of the module side walls 27, 28 which is facing away from the reception compartments 10. It is advantageous if the housing intermediate module 17a is designed such that the upper module side wall 27 and the lower module side wall 28 are wall sections of a one-piece intermediate module side wall 32, which projects from the module horizontal wall 25 both in the upward and in the downward direction, said wall sections directly merging into one another in the axial direction of the vertical axis 3. With its outer edge 29, the module horizontal wall 25 is integrally formed on the inner surface of the intermediate module side wall 32.

The intermediate module side wall 32 of each housing intermediate module 17a at the same time forms a part of two compartment side walls 16, these being the compartment side wall 16 of the reception compartment 10 located above the housing intermediate module 17a and the compartment side wall 16 of the reception compartment 10 located immediately below the housing intermediate module 17a. In other words: with its upper module side wall 27 and its lower module side wall 28, the housing intermediate module 17a simultaneously contributes to the formation of the compartment side walls 16 of the reception compartments 10 located above and below the housing intermediate module 17a.

At its upper module side wall 27, each housing intermediate module 17a is coupled to the housing module 17 placed above. At its lower module side wall 27, each housing intermediate module 17a is coupled to the housing module 17 placed below. The coupling is based on the coupling devices 18 mentioned above, which are preferably designed as latching connection devices 19.

In order to ensure that the compartment side walls 16 completely close off the associated reception compartment 10 irrespective of the multi-part structure in the height direction 3, the housing modules 17 immediately above and below the housing intermediate module 17a in the height direction 3 preferably lie with their whole surface on the end face 37 of the associated module side wall 27, 28, which is oriented in the axial direction of the vertical axis 3.

If the storage container 1 comprises several housing intermediate modules 17a located on top of one another in the vertical direction 3, the reception compartment 10 between two housing intermediate modules 17a located on top of one another is in each case laterally bounded by a compartment side wall 16 composed of the upward-projecting upper module side wall 27 of the respective lower housing intermediate module 17a and the downward-projecting lower module side wall 28 of the housing intermediate module 17a located immediately above.

In principle, the height dimensions—which can be designated as wall height—of the upper module side wall 27 and the lower module side wall 28 can be identical in at least one and preferably in each housing intermediate module 17a. In a preferred design, however, which is implemented in the illustrated embodiment, the two module side wall 27, 28 of at least one and preferably of each housing intermediate module 17a have wall heights which differ from one another in the axial direction of the vertical axis 3, so that they project to different degrees from the associated module horizontal wall 25 in the vertical direction 3 of the container housing 2.

The upper module side wall 27 is preferably higher than the downward-projecting lower module side wall 28.

The lower housing end module 17b preferably has lower end wall 33, which is oriented at right angles to the vertical axis 3 and forms the base wall of a reception compartment 10 placed above. The upper housing end module 17c expediently has an upper end wall 34, which is likewise oriented at right angles to the vertical axis 3 and bounds the topmost reception compartment 10 of the storage container 1, which is placed below, at its top side.

From the outer edge of the lower end wall 33 of the lower housing end module 17b, an upper module side wall 35 with the same circumferential shape as the intermediate module side wall 32 of the housing intermediate module 17a placed above projects upwards in the height direction 3. In a comparable way, a lower module side wall 36, the circumferential shape of which expediently likewise corresponds to that of the housing intermediate module 17a placed below, projects downwards from the outer edge of the upper end wall 34. In the assembled state of the container housing 2, the upper module side wall 35 of the lower housing end module 17b is therefore supported in the axial direction of the vertical axis 3 on the downward-oriented end face 37 of the lower module side wall 36 of the housing intermediate module 17a placed above. In a comparable way, the lower module side wall 36 of the upper housing end module 17c is supported on the upward-oriented end face 37 of the upper module side wall 27 of the housing intermediate module 17a placed immediately below.

In this way, the compartment side wall 16 of the lowermost reception compartment 10 is formed by the upper module side wall 35 of the lower housing end module 17b and by the lower module side wall 28 of the housing intermediate module 17a placed above. The compartment side wall 16 of the topmost reception compartment 10 is furthermore jointly formed by the lower module side wall 28 of the upper housing end module 17c and the upper module side wall 27 of the housing intermediate module 17a placed immediately below.

In embodiments not shown in the drawing, the lower housing end module 17b does not have an upper module side wall 35, its lower end wall 33 being in direct contact with the lower module side wall 28 of the housing intermediate module 17a placed above. In an embodiment which is likewise not illustrated, the upper housing end module 17c does not have a lower module side wall 36, sitting directly on the upper module side wall 27 of the housing intermediate module 17a placed below.

Housing modules 17 arranged directly on top of one another in the vertical direction 3 are preferably coupled to one another at their facing upper and lower side walls 27, 28. The coupling is preferably established in the region of the vertically oriented end faces 37 of the module side walls 27, 28, 35, 36. In any case, the housing modules 17 contact one another in such a way that they support one another by their facing end faces 37. The coupling devices 18 are preferably designed such that they clamp the contacting upper and lower module side walls 27, 28, 35, 36 together at their facing end faces 37.

In the illustrated storage container 1, latching connection devices 19 of a particularly advantageous design are provided for the paired coupling of housing modules 17 which are adjacent in the height direction 3. These are described below.

To implement the latching connection devices 19, each upper module side wall 27, 35 has a plurality of first latching means 42 arranged at a distance from one another in the circumferential direction of the respective module side wall 27, 35, while each lower module side wall 28, 36 has a corresponding number of second latching means 43 distributed in the same way. The term “circumferential direction” of the module side wall denotes the direction around the vertical axis 3. As adjacent housing modules 17 are fitted to one another, the first and the second latching means 42, 43 engage with one another in pairs and form a latching interconnection which has the effect that the upper and lower module side walls 27, 28 are clamped to one another in the height direction 3.

The first and the second latching means 42, 43 are expediently provided only on those sections of the module side walls 27, 28, 35, 36 which form the two lateral compartment side wall sections 16a.

The first latching means 42 are expediently designed as latching hooks 44, which project upwards in the height direction 3 and support a latching projection 45, which protrudes at right angles to the vertical axis 3 and in particular extends towards the interior of the associated reception compartment 10.

The second latching means 43 on the lower module side wall 28 in each case consist of a latching edge 46 pointing upwards in the height direction 3. In the latched state, each latching edge 46 is overlapped by one of the latching projections 45 on the top side, so that a positive engagement ensues in the height direction 3 of the container housing 2.

The lower module side wall 28, 36 provided with the latching edge 46 is preferably at least partially hollow and defines at least one plug-in receptacle 47 which is open in the downward direction towards the adjacent upper module side wall 27. The associated latching hook 44 dips into this plug-in receptacle 47.

In each of its two wall sections contributing to the formation of the lateral compartment side wall sections 16a, the lower module side wall 28, 36 preferably has a groove-like plug-in receptacle 44, which extends in the axial direction of the longitudinal axis 4 and into which all of the associated latching hooks 44 dip together.

Each latching edge 46 is expediently represented by the rim of a window-type opening 48, which is formed in the lower module side wall 28, 36 and laterally opens into the plug-in receptacle 47. This window-type opening 48 is expediently provided in a lateral boundary wall 50 of the plug-in receptacle 44, which is assigned to the interior of the reception compartment 10 and belongs to the lower module side wall 28, 36.

The upper module side wall 27, 35 and/or the lower module side wall 28, 36 is/are preferably double-walled at least in the region of the coupling devices 18. The above-mentioned boundary wall 50 is preferably represented by the inner wall section of the double-walled module side wall 27, 35, 28, 36, which bounds the reception compartment 10 located at the same level. The plug-in receptacle 44 is preferably represented by the interior of the double-walled structure.

Concerning the latching connection devices 19, it should be said that the first and the second latching means 42, 43 can also be interchanged in terms of their mounting on the upper module side wall 27, 35 and the lower module side wall 28, 36.

On its top side, the upper housing end module 17c is expediently bounded by a cover wall 49, on the upward-oriented outside of which is provided a bow-shaped carrying handle 52, which can be gripped with one hand for transporting the storage container 1. The carrying handle 52 is expediently mounted pivotably on the cover wall 49, the pivot axis 53 preferably extending in the width direction of the container housing 2.

The carrying handle 52 can preferably be folded to the cover wall 49 into a position of non-use, in which it expediently comes to lie in a surface recess 54 of the cover wall 49. For use, the carrying handle 52 can be swivelled into an upright position of use.

In the illustrated embodiment, the upper end wall 34 and the cover wall 49 are one and the same component of the top housing end module 17c. In an embodiment not shown in the drawing, the cover wall 49 is provided in addition to the upper end wall 34 and placed above the latter in the height direction 3, acting as a cover plate of an upper housing end module 17c designed as a container module.

Each of the drawer elements 12 expediently has a base wall 55, which is preferably plate-shaped. Around the edge of the base wall 55, there extends an outer wall 56, which projects upwards in the axial direction of the vertical axis 3 and, together with the base wall 55, bounds a drawer interior 57 for storing objects. If the drawer element 12 is at least partially pulled out of the associated receptacle compartment 10 at the front side 6 of the container housing 2, the drawer interior 57 is open towards the top and accessible for placing or removing objects.

The drawer interior 57 can be divided into individual interior sections by means of partitions not illustrated in detail. In addition, the drawer element 12 can have a removable or a pivotably mounted cover.

On the outside, which faces away from the drawer interior 57, of a front outer wall section 58 of the drawer element 12, which lies in the region of the compartment opening 11 in the pushed-in state, there is expediently provided a handle 59, on which the drawer element 12 can be gripped to pull it out of or to push it back into the drawer element 12.

The housing modules 17 and the drawer elements 12 expediently consist of a plastic material.

1. A storage container provided with a modular container housing, which has a plurality of housing modules arranged above one another in a height direction and coupled to one another in pairs in a way which prevents their lifting off from one another and which is provided with a plurality of reception compartments, each bounded by two housing modules located directly above one another and open at a front side of the container housing, for pull-out and push-in drawer elements, wherein at least one or each housing module located between two reception compartments is designed as a housing intermediate module, which is provided with a module horizontal wall extending at right angles to the height direction between the two reception compartments and with an upwards extending module side wall, which is arranged and made in one piece with the module horizontal wall at the edge of the module horizontal wall
wherein at least one housing intermediate module has, in addition to an upper module side wall which projects beyond the module horizontal wall in the upward direction, a lower module side wall, which projects beyond the module horizontal wall in the downward direction and therefore the housing intermediate module contributes to the formation of both a compartment side wall which laterally bounds the reception compartment located above the housing intermediate module and a compartment side wall which laterally bounds the reception compartment located below the housing intermediate module, wherein the housing intermediate module is coupled at its upper module side wall to a housing module located above and at its lower module side wall to a housing module located below, in each case in a way which prevents lifting-off.

2. The storage container according to claim 1, wherein, in each housing intermediate module, the module horizontal wall is surmounted by an upper module side wall in the upward direction and by a lower module side wall in the downward direction.

3. The storage container according to claim 1 wherein the container housing comprises a plurality of housing intermediate modules, which are located immediately on top of one another and coupled to one another in a way which prevents lifting-off from each other.

4. The storage container according to claim 1, wherein at least one or each compartment side wall comprises an upper or lower module side wall of a housing intermediate module and a module side wall of the housing module which is immediately adjacent in the height direction.

5. The storage container according to claim 4, wherein the compartment side wall of at least one or of each reception compartment located between two housing intermediate modules which are arranged immediately on top of one another comprises the upward-projecting upper module side wall of the respective lower housing intermediate module and the downward-projecting lower module side wall of the respective housing intermediate module located above, the housing intermediate modules being coupled to one another at their module side walls which face one another in the height direction.

6. The storage container according to claim 1, wherein that the housing modules comprise a lower housing end module located at the underside of the container housing and an upper housing end module located at the top side of the container housing, wherein each of these two housing end modules is coupled to a housing intermediate module located adjacent in the height direction of the container housing.

7. The storage container according to claim 6, wherein the lower housing end module has an upper module side wall, which projects upwards from a lower end wall bounding a lowermost reception compartment on the underside and which is coupled to the downward-projecting lower module side wall of the housing intermediate module located immediately above, and/or wherein the upper housing end module has a lower module side wall, which projects downwards from an upper end wall bounding a topmost reception compartment on the top side and which is coupled to the upward-projecting upper module side wall of the housing intermediate module located immediately below.

8. The storage container according to claim 6 wherein the upper housing end module is bounded at its top side by a cover wall, on the upward-oriented outside of which a bow-shaped carrying handle is arranged, in particular pivotably.

9. The storage container according to claim 8, wherein the lower housing end module has an upper module side wall, which projects upwards from a lower end wall bounding a lowermost reception compartment on the underside and which is coupled to the downward-projecting lower module side wall of the housing intermediate module located immediately above, and/or wherein the upper housing end module has a lower module side wall, which projects downwards from an upper end wall bounding a topmost reception compartment on the top side and which is coupled to the upward-projecting upper module side wall of the housing intermediate module located immediately below, wherein the cover wall is directly represented by the upper end wall of the upper housing end module.

10. The storage container according to claim 1 wherein the two module side walls of at least one or of each housing intermediate module have wall heights which differ from one another, so that they project to different degrees from the associated module horizontal wall in the height direction of the container housing.

11. The storage container according to claim 1, wherein, in at least one or in each housing intermediate module, the upward-projecting module side wall is higher than the downward-projecting lower module side wall.

12. The storage container according to claim 1, wherein housing modules which are immediately adjacent to one another in the height direction are coupled to one another in the region of their module side walls by latching using mutually engaging latching means.

13. The storage container according to claim 12, wherein each upward-projecting upper module side wall has several first latching means and each downward-projecting lower module side wall (28, 36) has a corresponding number of second latching means which are complementary to the first latching means, wherein the first or the second latching means are designed as latching hooks projecting from the associated module side wall in the height direction and the other latching means comprise a latching edge, which can be engaged from behind by a latching hook.

14. The storage container according to claim 1, wherein each compartment side wall, apart from a compartment opening of the associated reception compartment provided at the front side of the container housing for access to the drawer element, extends as a closed entity around the associated reception compartment.

15. The storage container according to claim 1, wherein a drawer element is provided in each reception compartment in a pull-out and push-in arrangement.

16. The storage container according to claim 15, wherein the drawer element has a base wall and an upward-projecting outer wall extending around the edge of the base wall, wherein a drawer interior is bounded by the base wall and the outer wall, and wherein a handle located on the outside, which faces away from the drawer interior, of a front outer wall section of the drawer element.

17. The storage container according to claim 8, wherein the carrying handle is pivotably arranged on the cover wall.

18. The storage container according to claim 13, wherein the latching edge is assigned to a plug-in receptacle formed in the associated module side wall to accommodate the latching hook.

19. The storage container according to claim 18, wherein the latching edge is represented by a rim of a window-type opening of the respective module side wall which laterally opens into the plug-in receptacle.
